(19) United States
(12) Patent Application Publication
(10) Pub. No.: US 2026/0116389 A1
(43) Pub. Date: Apr. 30, 2026

(54) METHOD FOR OPERATING A PLURALITY OF ASSISTANCE SYSTEMS OF A VEHICLE

(71) Applicant: MERCEDES-BENZ GROUP AG, Stuttgart (DE)

(72) Inventors: Reinhard GLANG, Bad Liebenzell (DE); Roman JANULIK, Sindelfingen (DE); Hubert REHBORN, Sindelfingen (DE)

(21) Appl. No.: 19/149,203

(22) PCT Filed: Jan. 14, 2024
(86) PCT No.: PCT/EP2024/050744

§ 371 Date: Jul. 18, 2025

(30) Foreign Application Priority Data
Jan. 19, 2023 (DE) 10 2023 000 160.0

(51) Int. Cl. B60W 30/182; B60W 50/14

(52) U.S. Cl. CPC B60W 30/182; B60W 50/14; B60W 2540/215; B60W 2552/05; B60W 2555/20

(57) ABSTRACT

A plurality of assistance systems of a vehicle coupled to a central computer unit are divided into a number of categories. Assistance systems of a category are deactivated depending on a detected current geoposition of the vehicle. Assistance systems of a further category are adjusted depending on detected dynamic factors.

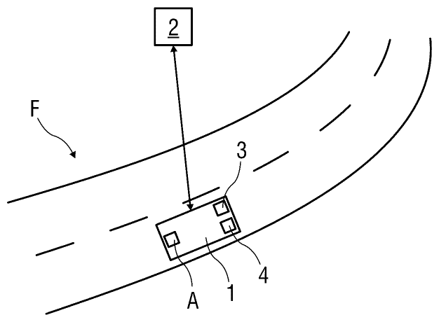

### BACKGROUND AND SUMMARY OF THE INVENTION

Exemplary embodiments of the invention relate to a method for operating a plurality of assistance systems of a vehicle, which is coupled to a central computer unit in a data technical manner or is coupled in a situation-dependent manner.

A method for supporting a driver when driving a motor vehicle having a driver assistance system and a motor vehicle with a system selection device are known from DE 10 2010 009 133 A1. The method provides that, during operation of the motor vehicle, driving data is continuously recorded by means of a vehicle sensor device and transmitted to a system selection device for evaluation, and the appropriate driver assistance system(s) are selected for activation by the system selection device depending on a result of the evaluation if at least one driver assistance system suitable for the current journey of the motor vehicle is present in the motor vehicle. Here, before automatic activation, an evaluation of one or more events that led to the selection of the driver assistance system(s) is carried out.

US 2020/0001893 A1 describes a method for operating a motor vehicle with several driver assistance systems. Here, the method comprises setting a support parameter via an operating interface of the motor vehicle, wherein the support parameter indicates the extent to which a driver desires support from a driver assistance system. Furthermore, the method comprises setting an additional parameter via an operating interface, wherein the additional parameter relates to the driving operation of the vehicle. Depending on the support parameter and the additional parameter, an operating parameter is specified for each driver assistance system by a processing device of the motor vehicle, according to which the respective driver assistance system is operated.

Moreover, DE 10 2011 083 944 A1 describes a method for activating an assistance system in a vehicle. Here, following a request by a driver to activate a driver assistance system, it is checked whether the driver is suitable to use the desired driver assistance system. Activation of the desired driver assistance system is carried out depending on the suitability of the driver.

Exemplary embodiments of the invention are directed to a novel method for operating a vehicle with at least one assistance system.

A method for operating a plurality of assistance systems of a vehicle, which is coupled to a central computer unit for data purposes or is coupled depending on the situation, provides according to the invention that the assistance systems are divided into a number of categories, wherein assistance systems of a category are deactivated depending on a detected current geoposition of the vehicle and assistance systems of a further category are adapted depending on detected dynamic factors.

By using the method, in particular by deactivating the assistance systems of the category and adjusting the assistance systems of the further category, a user of the vehicle has the opportunity to test it under comparatively extreme conditions. For example, in such driving conditions of the vehicle, weak points in the physical properties of the vehicle, for example, with regard to its aerodynamics, chassis, braking system, etc. can be identified.

By means of the method, the vehicle can be used for a purpose other than that for which it has been optimized, for example, driving in a city or on a motorway. On a racetrack, a conventional system that dynamically adjusts the assistance systems depending on continuous monitoring of driving characteristics would react inadequately under racetrack conditions. This conventional system would then cause the assistance systems to adjust under the assumption that an optimization criterion is to comply with traffic regulations and/or prevent driving maneuvers that are considered unsafe in a city or on a highway.

In particular, the method makes possible a more comfortable, user-specific configuration of the vehicle for a racetrack.

In a design of the method, when it is determined, by means of the recorded geoposition of the vehicle, that the vehicle is on a racetrack, the assistance systems of the one category are deactivated. In particular, when using the method, it is possible for the user to be able to drive the vehicle on the racetrack without, for example, a lane departure warning system and/or a distance control system of the vehicle intervening in a corrective manner. By using the method, the user can drive the vehicle, in particular on a racetrack under racetrack conditions, without an assistance system of the one category intervening in the driving operation of the vehicle, for example, in order to avoid a suspected collision with a vehicle ahead since the distance between the two vehicles falls below a predetermined threshold.

When it is determined that the vehicle is on a racetrack, a distance control device, in a further design, a lane departure warning system, a curve warning system, and/or a device for controlling driving dynamics is/are deactivated as assistance systems of the category. In an activated state, such assistance systems can restrict testing of vehicle functions on a racetrack, making it impossible, for example, to identify weak points in the physical properties of the vehicle.

In a possible design, the assistance systems of the category are reactivated after the vehicle has left the racetrack, as determined based on a recorded geoposition, such that driving safety is improved, particularly through situation-dependent intervention of the activated assistance systems, when driving the vehicle, for example, in a city or on a motorway. The respective assistance system intervenes, corresponding to its function, for example, in order to keep the vehicle in its lane or to maintain a distance to a vehicle ahead in order to maintain the predetermined threshold.

In a design, the entry of the vehicle onto the racetrack is detected by means of signals from on-board surroundings sensors. For example, this detection is carried out to verify the plausibility of the geoposition of the vehicle relative to the racetrack, which is ascertained by means of digital map data. For example, signs pointing to the racetrack can be used to ascertain that the racetrack is a destination of the vehicle and the vehicle will drive on the racetrack.

In a possible development, criteria such as the prevailing weather conditions and the road surface of the racetrack are recorded as dynamic factors. For example, if visibility is relatively poor due to fog, then the fog lights of the vehicle can be automatically switched on. Switching on a rear fog light can also be carried out automatically when visibility falls below a predetermined value. Traction control can also remain activated as a dynamic factor if a wet road surface is detected. The configuration, particularly the adjustment of the assistance systems, is thus carried out taking surrounding conditions into consideration.

In a design, the most frequently used configurations of the assistance system or the assistance systems in the further category can be offered to a user of the vehicle for selection for the respective racetrack. If it is detected that the vehicle is on a racetrack, the configurations are displayed to the user, allowing them to select the desired configurations by confirming, such that the individual assistance systems do not have to be adjusted individually. For example, the configurations are specific to a racetrack. For example, a configuration of a drive unit of the vehicle is set to aggressive driving behavior.

In a further design, the respective deactivation and/or configuration of the respective assistance system is offered depending on the driver characteristics of the user of the vehicle. For example, if the user of the vehicle is a comparatively good driver and a wet road surface has been detected, then the assistance systems are deactivated. However, if the user is a mediocre driver and the road surface is wet, the traction control of the vehicle, for example, remains activated.

Furthermore, in a design of the method, it is provided that all configurations of the assistance systems, at least in the further category for the respective racetrack, are transmitted to the central computer unit and stored there. Thus, the configurations of the assistance systems for the respective racetrack are available and can be retrieved or offered to a user of the vehicle or a further vehicle when the vehicle or a different vehicle is on the respective racetrack.

Exemplary embodiments of the invention are explained in more detail below by means of a drawing.

### BRIEF DESCRIPTION OF THE DRAWING FIGURE

Here are shown in:

The sole FIGURE, schematically, a track section of a racetrack with a vehicle and a central computer unit.

### DETAILED DESCRIPTION

The only FIGURE shows a track section F of a racetrack with a vehicle 1 and a central computer unit 2.

It is generally known that using a vehicle 1 on a racetrack is a comparatively popular hobby among users of vehicles 1, in particular sports vehicles. The vehicle 1 has a plurality of assistance systems A that intervene in the driving operation of the vehicle 1, for example, in order to avoid a collision between the vehicle 1 and a potential collision object. If the vehicle 1 leaves a lane, for example, due to the inattention of its user, then a lane departure warning system performs a steering movement in order to guide the vehicle 1 back into its lane.

If the driver of the vehicle 1 has activated its device for controlling distance, the vehicle 1 follows a vehicle ahead at a predetermined distance. If this distance gets smaller, for example, due to deceleration of the vehicle ahead and/or acceleration of the vehicle 1, the vehicle 1 is braked in order to increase the distance to the vehicle ahead again.

All of these assistance functions are undesirable for the user of the vehicle 1 when driving the vehicle 1 on a racetrack, since the user wants to test their vehicle 1 under extreme conditions on the racetrack without the intervention of an assistance system A. For example, while driving the vehicle 1, physical properties of the vehicle 1 can be tested, allowing weak points, for example, with regard to aerodynamics, a chassis, a braking system, etc. of the vehicle 1 to be identified. In particular, testing of the vehicle 1 with fully or partially deactivated assistance systems A should be enabled.

A method for operating a plurality of assistance systems A of the vehicle 1 is described below. Here, the vehicle 1 is coupled to a central computer unit 2 for data purposes, or the vehicle 1 can be coupled to the central computer unit 2 depending on the situation. For example, the vehicle 1 comprises, as assistance systems A, a distance control device, a lane departure warning system, a curve warning system, and a device for controlling vehicle dynamics.

The assistance systems A of the vehicle 1 are allocated to two categories, wherein the assistance systems A are activated, deactivated, or adjusted depending on a current geoposition of the vehicle 1 and dynamic factors, for example the current weather situation and/or driver characteristics of a user of the vehicle 1.

The assistance systems A allocated to a category are activated and deactivated depending on the geoposition of the vehicle 1 and assistance systems A allocated to a further category are adjusted depending on recorded present dynamic factors, which in particular represent temporal-spatial criteria.

The vehicle 1 has a navigation system 3 with a digital map, wherein a current geoposition of the vehicle 1 is regularly recorded by means of a position determining unit of the navigation system 3 and transmitted, for example, at cyclical intervals to the central computer unit 2.

If a geoposition of the vehicle 1 is recorded on the vehicle side, in particular by means of map data, and it is determined that the vehicle 1 is on a racetrack, then the assistance systems A of the one category are deactivated.

For example, determining that the vehicle 1 is on a racetrack can be carried out by means of a database created and stored in a telematics system of the vehicle 1, which contains location data from various racetracks. For example, the database can be manually expanded by the user of the vehicle 1.

It can also be provided that the user of the vehicle 1 actively enters into a so-called microservice, in particular an application program, of the vehicle 1 that they are on a racetrack with their vehicle 1.

If it is determined that the vehicle 1 is on a racetrack, the assistance systems A of the vehicle 1 allocated to the one category are deactivated, adapted to this racetrack. These assistance systems A are in particular the device for controlling distance, the lane departure warning system, the curve warning system, and the device for controlling vehicle dynamics.

Signals detected by a surroundings sensor 4 and/or signals received by the central computer unit 2 are evaluated, for example, on the vehicle side and thus dynamic factors, such as the current weather situation and road characteristics, are ascertained.

Depending on the dynamic factors ascertained, the assistance systems A and/or vehicle functions allocated to the other category are adjusted. It can also be provided that the assistance systems A of the one category are adjusted depending on determined dynamic factors, for example, due to comparatively low visibility. In particular when it is raining, the traction control system is not deactivated, such that vehicle wheels do not spin when the vehicle 1 starts moving, and a lateral swerving of the vehicle 1 is largely prevented.

For a respective racetrack, the most frequently used configurations, for example regarding tire pressure, settings of a rear spoiler and/or a front splitter, etc., are offered to the user of the respective vehicle 1 for selection. If the user selects one of the offered configurations, the assistance systems A, for example of both categories, are deactivated or adjusted to the dynamic factors.

In a design, the vehicle 1, in particular the microservice, offers the respective configuration via a rule-based system with driver characteristics of the vehicle, the current dynamic factors, and the existing assistance systems A of the vehicle 1 in a suitable configuration. If, for example, the user of the vehicle 1 is a comparatively good driver and the road is wet from rain, the assistance systems A are deactivated.

If the user is a mediocre driver and the road is wet from rain, then a corresponding configuration provides that an assistance system A for the traction control of the vehicle 1 remains activated.

A drive unit of the vehicle 1 is configured for offensive driving behavior when it is determined that the vehicle 1 is on a racetrack.

The method also provides that an acoustic output from assistance systems A adjusted to the dynamic factors is deactivated when the vehicle 1 is on a racetrack. This allows a test run of the vehicle 1 to be carried out without potentially disturbing acoustic signals being emitted to the user.

The user of the vehicle 1 is shown all setting changes made on the vehicle, particularly those relating to the assistance systems A, on a display unit, in particular, for example, an infotainment system. Here, the user has the option of confirming or rejecting the setting changes made, i.e., configurations, by pressing a button. The user may intend to drive the vehicle 1 in a conventional manner, i.e., with the usual configurations for city driving or motorway driving, despite the fact that the vehicle is on a racetrack.

After the vehicle 1 has left the racetrack and the departure is detected by the vehicle, for example, by means of the map data of the navigation system 3, the assistance systems A that were deactivated due to the racetrack are reactivated, and the configurations for conventional driving of the vehicle 1 are carried out. This occurs either automatically or after confirmation by the user of the vehicle 1.

By means of the central computer unit 2, with which the vehicle 1 is coupled in a data-technical manner, all changed configurations for the racetrack are saved for the respective vehicle 1.

During the next visit to the racetrack by the vehicle 1 and the user, the configurations are retrieved, for example automatically, from the central computer unit 2 and offered to the user for adjustment. The user then has the option, particularly depending on recorded dynamic factors, to select the settings of the vehicle 1 from the last visit or, if applicable, from one of the last visits.

For example, the central computer unit 2 and an existing evaluation option are used to analyze how many vehicles 1 on racetracks make use of the microservice.

Furthermore, the method provides the user with an overview of racetracks and respective individual configurations, wherein a specific racetrack is recommended to the user, for example based on their driving behavior and driver characteristics.

In a possible design, the user of the vehicle 1 is provided with individual, route-dependent suggestions which result in the vehicle 1 being able to increase the driving speed of the vehicle 1 based on setting changes, for example by reducing or increasing the tire pressure, rear spoiler settings, front splitter settings, etc.

The user of the vehicle 1 is also offered the opportunity to adopt configurations of vehicle settings from other users, for example with regard to the traction control.

Although the invention has been illustrated and described in detail by way of preferred embodiments, the invention is not limited by the examples disclosed, and other variations can be derived from these by the person skilled in the art without leaving the scope of the invention. It is therefore clear that there is a plurality of possible variations. It is also clear that embodiments stated by way of example are only really examples that are not to be seen as limiting the scope, application possibilities or configuration of the invention in any way. In fact, the preceding description and the description of the FIGURES enable the person skilled in the art to implement the exemplary embodiments in concrete manner, wherein, with the knowledge of the disclosed inventive concept, the person skilled in the art is able to undertake various changes, for example, with regard to the functioning or arrangement of individual elements stated in an exemplary embodiment without leaving the scope of the invention, which is defined by the claims and their legal equivalents, such as further explanations in the description.

1-9. (canceled)

10. A method for operating a plurality of assistance systems of a vehicle, the method comprising:
dividing the plurality of assistance systems into a number of categories;
determining a current geoposition of the vehicle;
deactivating, depending on the determined current geoposition of the vehicle, assistance systems of a first category of the number of categories;
detecting dynamic factors; and
adjusting assistance systems of a further category on the detected dynamic factors.

11. The method of claim 10, wherein when it is determined, based on the determined geoposition of the vehicle, that the vehicle is on a racetrack, the assistance systems of the first category are deactivated.

12. The method of claim 10, wherein when it is determined that the vehicle is on a racetrack, a distance control device, a lane departure warning system, a curve warning system, or a device for controlling vehicle dynamics are deactivated as the assistance systems of the first category.

13. The method of claim 11, wherein the assistance systems of the first category are reactivated after leaving the racetrack, which is determined based on a recorded geoposition of the vehicle.

14. The method of claim 11, wherein driving on the racetrack by the vehicle is detected based on signals recorded by a vehicle-side surroundings sensor system.

15. The method of claim 11, wherein a prevailing weather situation or road surface characteristics of the racetrack is recorded as at least one of the dynamic factors.

16. The method of claim 11, wherein a most frequently used configuration of the assistance system(s) of the further category for the respective racetrack are offered to a user of the vehicle for selection.

17. The method of claim 16, wherein a respective deactivation or configuration is offered depending on driver characteristics of the user of the vehicle.

18. The method of claim 11, wherein all configurations of the assistance systems of at least the further category for the respective racetrack are transmitted to a central computer unit and stored by the central computer unit.
